(19) United States
(12) Patent Application Publication
(10) Pub. No.: US 2007/0100621 A1
(43) Pub. Date: May 3, 2007

(54) Data management of audio aspects of a data stream

(76) Inventors: Edward K.Y. Jung, Bellevue, WA (US); Royce A. Levien, Lexington, MA (US); Robert W. Lord, Seattle, WA (US); Mark A. Malamud, Seattle, WA (US); John D. Rinaldo JR., Bellevue, WA (US)

Correspondence Address: Searete LLC, Suite 110, 1756-114th Ave. S. E., Bellevue, WA, 98004, US

(21) Appl. No.: 11/413,271

(22) Filed: Apr. 28, 2006

Related U.S. Application Data
(63) Continuation-in-part of application No. 11/263,587, filed on Oct. 31, 2005.
(63) Continuation-in-part of application No. 11/264,701, filed on Nov. 1, 2005.
(63) Continuation-in-part of application No. 11/364,496, filed on Feb. 28, 2006.
(63) Continuation-in-part of application No. 11/376,627, filed on Mar. 15, 2006.
(63) Continuation-in-part of application No. 11/396,279, filed on Mar. 31, 2006.

(51) Int. Cl. G10L 17/00

(52) U.S. Cl. 704/246

(57) ABSTRACT

In one aspect, a method related to data management includes but is not limited to accepting input designating an audio aspect of an audio data stream; and accepting input for retaining at a high resolution the audio aspect of the audio data stream. In addition, other method, system, and program product aspects are described in the claims, drawings, and/or text forming a part of the present application.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC § 119(e) for provisional patent applications, for any and all parent, grandparent, great-grandparent, etc. applications of the Related Application(s)).

### RELATED APPLICATIONS

For purposes of the USPTO extra-statutory requirements, the present application constitutes a continuation-in-part of U.S. patent application Ser. No. 11/263,587, entitled Saved-Image Management, naming Royce A. Levien, Robert W. Lord, and Mark A. Malamud, as inventors, filed Oct. 31, 2005, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 11/264,701, entitled Conditional Alteration of a Saved Image, naming Royce A. Levien, Robert W. Lord, and Mark A. Malamud, as inventors, filed Nov. 1, 2005, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 11/364,496, entitled Imagery Processing, naming Edward K. Y. Jung, Royce A. Levien, Robert W. Lord, Mark A. Malamud, and John D. Rinaldo, Jr., as inventors, filed Feb. 28, 2006, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 11/376,627, entitled Data Management of a Data Stream, naming Edward K. Y. Jung, Royce A. Levien, Robert W. Lord, Mark A. Malamud, and John D. Rinaldo, Jr., as inventors, filed Mar. 15, 2006, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 11/396,279, entitled Data Management of an Audio Data Stream, naming Edward K. Y. Jung, Royce A. Levien, Robert W. Lord, Mark A. Malamud, and John D. Rinaldo, Jr., as inventors, filed Mar. 31, 2006, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present applicant entity has provided above a specific reference to the application(s) from which priority is being claimed as recited by statute. Applicant entity understands that the statute is unambiguous in its specific reference language and does not require either a serial number or any characterization, such as “continuation” or “continuation-in-part,” for claiming priority to U.S. patent applications. Notwithstanding the foregoing, applicant entity understands that the USPTO's computer programs have certain data entry requirements, and hence applicant entity is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### TECHNICAL FIELD

The present application relates, in general, to data management.

### SUMMARY

In one aspect, a method related to data management includes but is not limited to accepting input designating an audio aspect of an audio data stream; and accepting input for retaining at a high resolution the audio aspect of the audio data stream. In addition to the foregoing, other method aspects are described in the claims, drawings, and text forming a part of the present application.

In one aspect, a system related to data management includes but is not limited to circuitry for accepting input designating an audio aspect of an audio data stream; and circuitry for accepting input for retaining at a high resolution the audio aspect of the audio data stream. In addition to the foregoing, other system aspects are described in the claims, drawings, and text forming a part of the present application.

In one or more various aspects, related systems include but are not limited to circuitry and/or programming and/or electromechanical devices and/or optical devices for effecting the herein-referenced method aspects; the circuitry and/or programming and/or electromechanical devices and/or optical devices can be virtually any combination of hardware, software, and/or firmware configured to effect the herein-referenced method aspects depending upon the design choices of the system designer skilled in the art.

In one aspect, a program product includes but is not limited to a signal bearing medium bearing one or more instructions for accepting input designating an audio aspect of an audio data stream; and one or more instructions for accepting input for retaining at a high resolution the audio aspect of the audio data stream. In addition to the foregoing, other program product aspects are described in the claims, drawings, and text forming a part of the present application.

In addition to the foregoing, various other method, system, and/or program product aspects are set forth and described in the teachings such as the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1A depicts an implementation of an exemplary environment in which the methods and systems described herein may be represented;

FIG. 1B depicts an implementation of an exemplary environment in which the methods and systems described herein may be represented;

FIG. 2 depicts a high-level logic flowchart of an operational process;

FIG. 3 shows several alternative implementations of the high-level logic flowchart of FIG. 2;

FIG. 4 shows several alternative implementations of the high-level logic flowchart of FIG. 3;

FIG. 5 shows several alternative implementations of the high-level logic flowchart of FIG. 3;

FIG. 6 shows several alternative implementations of the high-level logic flowchart of FIG. 3;

FIG. 7 illustrates several alternative implementations of the high-level logic flowchart of FIG. 2;

FIG. 8 shows a high-level logic flowchart of an operational process;

FIG. 9 depicts a high-level logic flow chart of an operational process; and

FIG. 10 illustrates an alternate implementation of the high-level logic flowchart of FIG. 9.

The use of the same symbols in different drawings typically indicates similar or identical items.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

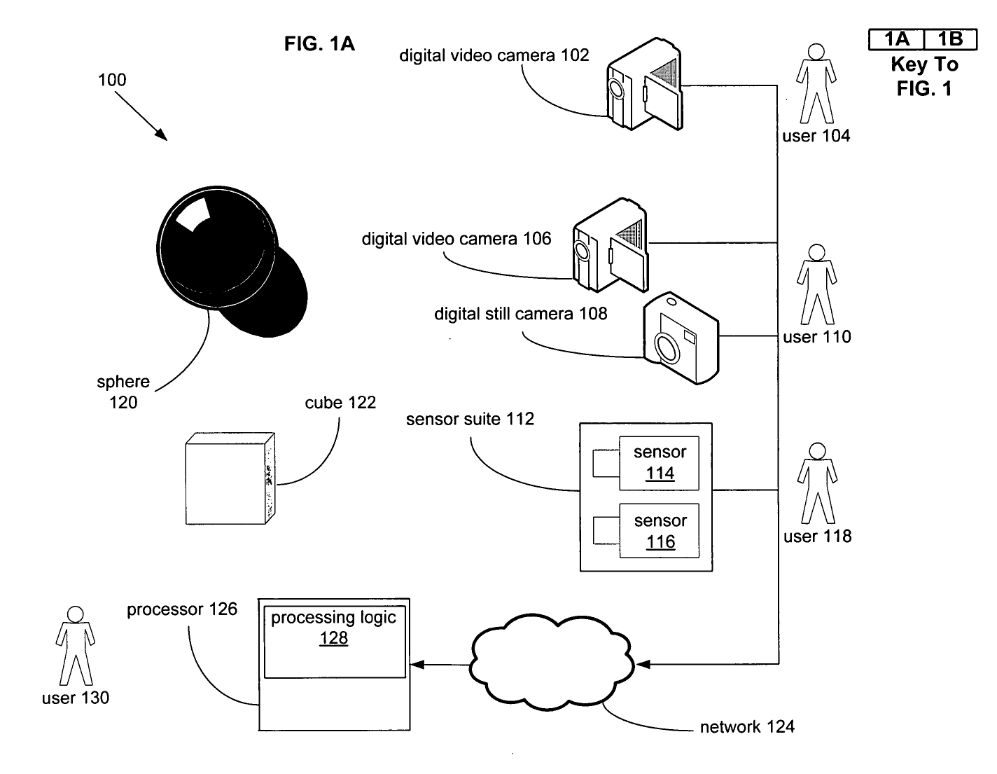

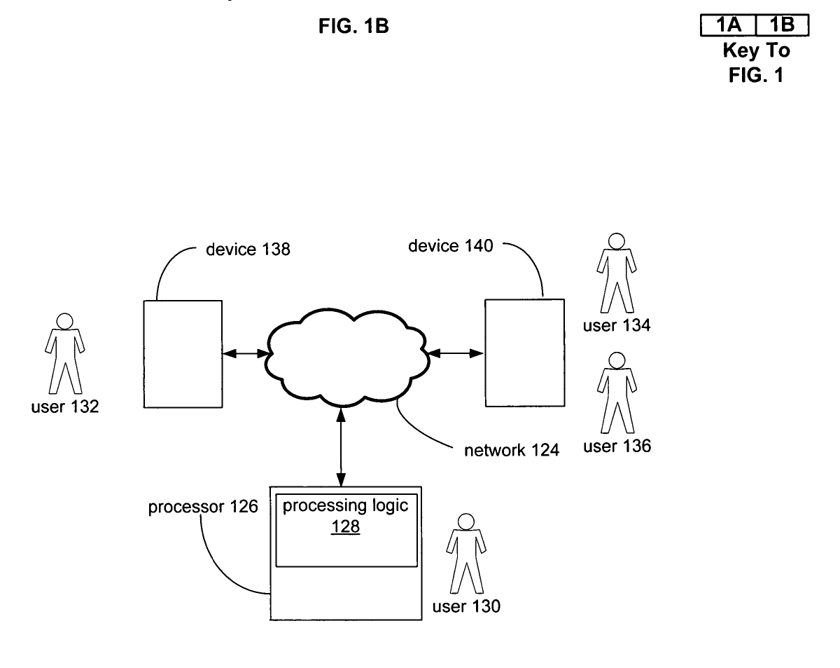

FIG. 1A depicts an implementation of an exemplary environment in which the methods and systems described herein may be represented. In the depicted exemplary environment 100, are illustrated a variety of exemplary sensors: a digital video camera 102 operated by one or more users represented by user 104, where the digital video camera 102 may have a capability to record audio input; a digital video camera 106 used in conjunction with a digital still camera 108, where the digital video camera 106 may have a capability to record audio input, both operated by one or more users represented by user 110; and a sensor suite 112 comprising more than one sensor represented by sensor 114 and sensor 116 (wherein the sensors 114 and 116 may be but need not be physically co-located, and may be but need not be of the same type, e.g., sensor 114 may be an infrared device and sensor 116 may be a radar device, or, e.g. sensor 114 may be a microphone and the sensor 116 may be an infrared/visible light device), the sensor suite being operated by one or more users represented by user 118. Taken by themselves, each of the sensors 114 and 116 are exemplary of single independent sensors, and further, either of the sensor 114 or 116 may be audio sensors. The exemplary sensors represent a variety of devices for the detection and/or the recording and/or the transmission of imagery, e.g., images, and/or audio aspects, e.g., instances of particular voices and/or instances of particular sounds, including but not limited to microphones, digital video cameras, digital still cameras, digital sensor (e.g. CCD or CMOS) arrays, and radar sets. The exemplary users 104, 110, and/or 118 may, for example, operate the exemplary sensors manually or may supervise and/or monitor their automatic operation. The exemplary users 104, 110, and/or 118 may operate the exemplary sensors in physical proximity to the sensors or remotely. The exemplary sensors may also operate autonomously without exemplary users 104, 110, and/or 118.

The exemplary sensors may be used to detect and/or record and/or transmit images and/or sounds and/or other data related to a wide variety of objects, represented in FIG. 1 by exemplary objects, a sphere 120 and a cube 122. The sphere 120 and/or the cube 122 may be reflectors and/or emitters of electromagnetic radiation such as visible light and/or microwaves, reflectors and/or emitters of particulate radiation such as electrons and/or neutrons, and/or reflectors and/or emitters of sonic energy. The sphere 120 and the cube 122 are representative of any object(s) or groups of objects, images and/or emitting and/or reflecting sources of sounds and/or other related data which may be detectable and/or recordable and/or transmissible by the exemplary sensors, including but not limited to persons, animals, buildings, roads, automobiles, trucks, aircraft, ships, spacecraft, landscape and/or seascape features, vegetation, and/or celestial objects. When used together in any given example herein, the exemplary sphere 120 and the exemplary cube 122 generally represent two distinct objects which may or may not be of the same or of a similar type, except where otherwise required by the context, e.g., a sphere 120 and a cube 122 used together in an example may represent a first particular object and a second particular object, e.g., a particular person and a particular building, or a particular first aircraft and a particular second aircraft, respectively. When used alone in any given example herein, the designated exemplary object, e.g., the sphere 120 or the cube 122, generally represents the same object, except where otherwise required by the context, e.g., a sphere 120 used alone in an example generally represents a single object, e.g., a single building, and a cube 122 used alone generally represents a single object, e.g., a particular person.

Each of the exemplary sensors may detect and/or record and/or transmit images and/or sounds and/or other related data of the exemplary objects in a variety of combinations and sequences. For instance, the digital video camera 102 may detect and/or record and/or transmit an image and/or sound and/or other related data of the sphere 120 and then an image and/or sound and/or other related data of the cube 122 sequentially, in either order; and/or, the digital video camera 106 may detect and/or record and/or transmit a single image and/or sound and/or other related data of the sphere 120 and the cube 122 together.

Similarly, the digital video camera 106 may detect and/or record and/or transmit an image and/or sound and/or other related data of the sphere 120 and of the cube 122 sequentially, in either order, and/or of the sphere 120 and the cube 122 together, before, after, partially simultaneously with, or simultaneously with an operation of the digital still camera 108. The digital still camera 108 may detect and/or record and/or transmit an image and/or sound and/or other related data of the sphere 120 and of the cube 122 sequentially, in either order, and/or of the sphere 120 and the cube 122 together, before, after, partially simultaneously with, or simultaneously with an operation of the digital video camera 106.

Similarly, the sensor 114 and the sensor 116 of the sensor suite 112 may detect and/or record and/or transmit an image and/or sound and/or other related data of the sphere 120 and of the cube 122 sequentially, in either order, and/or of the sphere 120 and the cube 122 together, before, after, partially simultaneously with, or simultaneously with respect to each other.

Such images and/or sounds and/or related data may be recorded and/or transmitted via a computer or computers represented by the network 124 and/or directly to a processor 126 and/or processing logic 128, which accept data representing imagery aspects and/or sounds and/or related data pertaining to the exemplary objects. The processor 126 represents one or more processors that may be, for example, one or more computers, including but not limited to one or more laptop computers, desktop computers, and/or other types of computers. The processing logic may be software and/or hardware and/or firmware associated with the processor 126 and capable of accepting and/or processing data representing imagery and/or sounds and/or other related data aspects of the exemplary objects from the exemplary sensors. Such processing may include but is not limited to comparing at least a portion of the data from one sensor with at least a portion of the data from the other sensor, and/or applying a mathematical algorithm to at least a portion of the data from one sensor with at least a portion of the data from the other sensor. Such processing may also include, but is not limited to, deriving third data from the combining at least a portion of the data from one sensor with at least a portion of the data from another sensor.

The digital video camera 102, the digital video camera 106, the sensor 114 and/or the sensor 116 (operating as components of sensor suite 112 or separately as single independent sensors) may be capable of detecting and/or recording and/or transmitting information representing audio input and accepting input representing information for the manipulation and/or retention of such audio information, including but not limited to accepting input for a designation of a reference designator in an audio data stream originating from one of the exemplary sensors via detection and/or transmission and/or playback; accepting input for a designation of a beginning demarcation designator in such an audio data stream; accepting input for a designation of an ending demarcation designator in such an audio data stream; and accepting input for retaining at a high resolution a portion of such an audio data stream beginning substantially at the beginning demarcation designator and ending substantially at the ending demarcation designator. Such input may include confirmation of previous input. Further, the processor 126 and/or the processing logic 128 may be capable of receiving such an audio data stream from the exemplary sensors and/or from other computing resources and/or capable of playback of such an audio data stream that has been previously retained within the processor 126 and/or the processing logic 128 and/or elsewhere. In addition, processor 126 and/or the processing logic 128 may be capable of accepting input representing information for the manipulation and/or retention of such audio information, including the input described herein in connection with the exemplary sensors.

With regard to accepting input designating an audio aspect of an audio data stream, such input may represent an indication from an exemplary user 104, 110, 118, and/or 130, or from the processor 126 and/or the processing logic 128, of an audio aspect, e.g., audio information of interest, such as a particular human voice or a particular mechanical sound, e.g., an auto engine, or the relative absence of sound, such as a relative silence between two human speakers or two musical phrases. Such designation may be for the purpose or purposes of, e.g., retention at high resolution, interactive review of the portion of the audio data stream of interest, or analysis of the portion of interest. An audio aspect may be characterized at least in part by a temporal beginning, a temporal ending, an intensity and/or range of intensities and/or distribution of intensities, a frequency and/or range of frequencies and/or distribution of frequencies.

With regard to input for a designation of a reference designator in an audio data stream, such input may represent an indication from an exemplary user 104, 110, 118, and/or 130, or from the processor 126 and/or the processing logic 128, of audio information of interest, such as a particular human voice or a particular mechanical sound, e.g., an auto engine, or the relative absence of sound, such as a relative silence between two human speakers or two musical phrases. The reference designator may be designated in the audio data stream such that it falls within and/or references a place within the portion of the audio data stream comprising the particular sound of interest. The reference designator may be designated via initiating input in a variety of ways, including but not limited to pressing a button on a computer interface device, manipulating features of a graphical interface such as pull-down menus or radio buttons, speaking into a microphone, and/or using the processor 126 and/or the processing logic 128 to initiate automatically such input when the data in an audio data stream satisfies some criteria for audio data of interest.

With regard to input for designation of a beginning demarcation designator in an audio data stream, such input may represent an indication from an exemplary user 104, 110, 118, and/or 130, or from the processor 126 and/or the processing logic 128, of a point in the audio data stream at which a portion of interest of the audio data stream begins, such as (but not limited to) the end a relative silence (e.g., silence except for background and/or artifact noise) occurring last before a designated reference designator, the beginning of the sound of interest or of one or more of the sounds accompanying a sound of interest, or the end of a sound occurring last before a designated reference designator. The beginning demarcation designator may be designated in the audio data stream such that it falls within and/or references a place at or near the beginning of the portion of the audio data stream comprising the particular sound of interest. The beginning demarcation designator may be designated via initiating input in a variety of ways, including but not limited to pressing a button on a computer interface device, manipulating features of a graphical interface such as pull-down menus or radio buttons, speaking into a microphone, and/or using the processor 126 and/or the processing logic 128 to initiate automatically such input when the data in an audio data stream satisfies some criteria for demarcation of audio data of interest.

With regard to input for designation of an ending demarcation designator in an audio data stream, such input may represent an indication from an exemplary user 104, 110, 118, and/or 130, or from the processor 126 and/or the processing logic 128, of a point in the audio data stream at which a portion of interest of the audio data stream ends. The ending demarcation designator may represent the point in the audio data stream falling at the end of a portion of interest, such as (but not limited to) the end a relative silence (e.g., silence except for background and/or artifact noise) occurring just after the end of the sound of interest or of one or more of the sounds accompanying a sound of interest, or the end of a sound occurring just after a designated reference designator. The ending demarcation designator may be designated in the audio data stream such that it falls within and/or references a place at or near the end of the portion of the audio data stream comprising the particular sound of interest. The ending demarcation designator may be designated via initiating input in a variety of ways, including but not limited to pressing a button on a computer interface device, manipulating features of a graphical interface such as pull-down menus or radio buttons, speaking into a microphone, and/or using the processor 126 and/or the processing logic 128 to initiate automatically such input when the data in an audio data stream satisfies some criteria for audio data of interest.

With regard to input for retaining at a high resolution a portion of an audio data stream, including but not limited to an audio aspect of an audio data stream, such high resolution retention includes but is not limited to storage of a relatively large amount of data, compared to storage of portions of the data stream not selected for high resolution retention, as described herein. Such input may include but is not limited to designation of a high resolution value, e.g., 0.5 Mb/second, and/or frequency spectrum characteristics, e.g., lower and upper frequency cut-offs. For example, the user 130 may provide input to the processor 126 and/or the processor logic 128 to identify a portion of a video and/or audio data stream for retention at high resolution, e.g., input designating an audio aspect of an audio data stream. The processor 126 and/or the processor logic 128 may accept the input, enabling the identified portion (e.g., a designated audio aspect) to be stored with high fidelity relative to the source video and/or audio and with a relatively small proportion of data (if any) discarded, while the portion or portions not selected may be stored at a relatively lower resolution, e.g., with a relatively higher proportion of data discarded to save storage resources.

Retention of a portion, e.g., an audio aspect, of an audio data stream at a relatively high resolution and retention of portions of the audio data stream not included in the portion retained at the high resolution may result in storage of the portion not included in the portion retained at the high resolution at one or more resolutions that do not use all of the data available, such that the portion not retained at the high resolution is degraded in storage. Degradation of a portion not included in the portion retained or designated for retention at high resolution may be achieved by retaining the not-included portion at one or more lower resolutions, where the one or more lower resolutions may be a function of the distance in the audio data stream between the portion to be retained at a high resolution and the portion to be retained at one or more lower resolutions, such as degrading blocks of data not included in the high resolution portion according to their distance from the high resolution portion (e.g., degrading to one lower resolution a portion between 0 and 60 seconds from the high resolution portion, and degrading to another, even lower resolution a portion between 60 and 120 seconds from the high resolution portion, and so on). One or more inputs may be accepted to set one or more rules by which a portion of an audio data stream not included in a portion designated for high resolution retention is degraded and/or retained at one or more lower resolutions. One or more inputs for degradation may be accepted to specify parameters including but not limited to one or more specific resolution values (e.g., 12 Kb/sec and/or 20 Kb/sec), one or more frequency range characteristics, and/or one or more frequency distribution characteristics. Degradation to one or more lower resolutions may be correlated to one or more specified frequency ranges and/or one or more specified frequency distribution characteristics, such as specific lower resolutions for all sounds above 100 Hz, and/or between 2 kHz and 20 kHz, and/or below 5 kHz, and/or one or more specific lower resolutions for all sounds conforming to a specific frequency distribution characteristic of a particular human voice or musical instrument. Degradation to one or more lower resolutions may be correlated to the time frame in which a portion of an audio data stream has been detected and/or recorded and/or transmitted and/or stored, e.g., audio data detected and/or recorded and/or transmitted and/or stored within a week may be retained at the resolution at which it was detected and/or recorded and/or transmitted and/or stored, while data detected and/or recorded and/or transmitted and/or stored between one and two weeks ago may be degraded to 80% of the resolution at which it was detected and/or recorded and/or transmitted and/or stored, and data detected and/or recorded and/or transmitted and/or stored between two and four weeks ago may be degraded to 60% of the resolution at which it was detected and/or recorded and/or transmitted and/or stored, and so on. One or more inputs may be accepted to confirm previous inputs or default values related to degrading data and/or retaining such data at a relatively lower resolution value. One or more inputs may be accepted for degrading a portion of an audio data stream not included in a portion designated for retention at high resolution. Inputs may include but not be limited to tactile, sonic, and/or visual inputs. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128, or it may be initiated by some combination of human and automated action.

In addition to accepting inputs for degrading to at least one lower resolution a portion of an audio data stream not included in a portion designated for retention at high resolution, degrading and/or retaining at a lower resolution a portion of an audio data stream not included in a portion designated for retention at high resolution may also be performed. Retention at one or more lower resolutions may be performed, e.g., by using one or more memory locations associated with and/or operably coupled to the digital video camera 102 and/or the digital video camera 106 and/or the sensor 114 and/or the sensor 116 and/or the processor 126 and/or the processing logic 128. Degradation may be performed by methods including but not limited to data compression and/or data redaction.

With respect to this example, input for the identification of a particular portion for retention at a relatively higher resolution does not preclude input for the storage of a distinct and/or an overlapping portion of the data stream at a distinct higher resolution compared to the retention resolution of one or more portions not identified for retention at a higher resolution, e.g., one or more portions of a data stream may be identified for retention at one or more relatively high resolutions. A particular portion identified for retention at high resolution may include more than one data set that may generally be considered to constitute a “frame” in a video and/or audio data stream. With respect to this example, digital video cameras 102 and/or 106 are representative of any sensor or sensor suite capable of detecting and/or recording and/or transmitting video and/or audio input as one or more data streams representing the video and/or audio information. Such input may be initiated in a variety of ways, including but not limited to pressing a button on a computer interface device, manipulating features of a graphical interface such as pull-down menus or radio buttons, speaking into a microphone, and/or using the processor 126 and/or the processing logic 128 to initiate automatically such input when the data in an audio data stream satisfies some criteria for audio data of interest.

With regard to retaining at a high resolution a portion of an audio data stream, e.g., an audio aspect of the audio data stream, such retention may include storage in computer memory, such as memory associated with and/or operably coupled to the processor 126 and/or the processing logic 128.

The exemplary sensors may be capable of detecting and/or recording and/or transmitting one or more imagery and/or sound and/or other related data aspects of the exemplary objects, the one or more imagery aspects being defined in part, but not exclusively, by exemplary parameters such as focal length, aperture (f-stop being one parameter for denoting aperture), t-stop, shutter speed, sensor sensitivity (such as film sensitivity (e.g., film speed) and/or digital sensor sensitivity), exposure (which may be varied by varying, e.g., shutter speed and/or aperture), frequency and/or wavelength, focus, depth of field, white balance (and/or white point, color temperature, and/or micro reciprocal degree or “mired”), and/or flash (sound aspects are described elsewhere herein). Some or all of the parameters that may define at least in part imagery and/or sounds and/or other related data aspects may have further defining parameters. For example, a frequency and/or wavelength parameter may be associated with one or more bandwidth parameters; and a flash parameter may be associated with one or more parameters for, e.g., duration, intensity, and/or special distribution. Note that although certain examples herein discuss bracketing and/or imagery aspects and/or exemplary parameters in the context of more or less “still” images for sake of clarity, techniques described herein are also applicable to streams of images, such as would typically be produced by digital video cameras 102/106 and thus the use of such, and other, exemplary terms herein are meant to encompass both still and video bracketing/aspects/parameters/etc. unless context dictates otherwise. For instance, the bracketing might include bracketing over, say, 20 frames of video.

Each of the exemplary sensors may detect and/or record and/or transmit one or more imagery and/or sounds and/or other related data aspects of an exemplary object at more than one setting of each of the available parameters, thereby bracketing the exemplary object. Generally, “bracketing” includes the imagery technique of making several images of the same object or objects using different settings, typically with a single imagery device such as digital video camera 106. For example, the digital video camera 106 may detect and/or record and/or transmit a series of imagery aspects of the cube 122 at a number of different f-stops; before, after, partially simultaneously with, and/or simultaneously with that series of imagery aspects, another digital video camera 106 and/or another type of sensor, such as sensor 114 may detect and/or record and/or transmit a series of imagery aspects of the sphere 120 and of the cube 122 at a number of different white balances. The processor 126 and/or the processing logic 128 may then accept, via the network 124 or directly, data representing the imagery aspects detected and/or recorded and/or transmitted by the digital video cameras 106 or by the digital video camera 106 and the sensor 114. The processor 126 and/or the processing logic 128 may then combine at least a portion of the data from one of the sensors with at least a portion of the data from the other sensor, e.g., comparing the data from the two sensors. For example, deriving an identity of color and orientation from the bracketing imagery aspect data of two cubes 122 from digital video camera 106 and sensor 114.

Exemplary digital video cameras 102 and/or 106 may also be capable of detecting and/or recording and/or transmitting video and/or audio input as one or more data streams representing the video and/or audio information. Exemplary users 104 and/or 110 and/or another person and/or entity such as user 130 may provide input to the digital video camera 102 and/or the processor 126 and/or the processing logic 128 to select at least a portion of a data stream representing the video and/or audio information for retention at high resolution (where retention at high resolution is as described herein), e.g., imagery such as an image of a particular object and/or an audio aspect such as an instance of a particular voice and/or an instance of a particular sound. With respect to this example, digital video cameras 102 and/or 106 are representative of any sensor or sensor suite capable of detecting and/or recording and/or transmitting video and/or audio input as one or more data streams representing the video and/or audio information.

Those skilled in the art will appreciate that the explicitly described examples involving the exemplary sensors (the digital video camera 102, the digital video camera 106, the digital still camera 108, and the sensor suite 112 including sensor 114 and sensor 116), the exemplary users (users 104, 110, and 118), the exemplary objects (the sphere 120 and the cube 122), the network 124, the exemplary processor 126, and the exemplary processing logic 128 constitute only a few of the aspects illustrated by FIG. 1A.

FIG. 1B depicts an implementation of an exemplary environment in which the methods and systems described herein may be represented. Users 130, 132, 134, and 136 may be participants in a teleconference conducted using voice-over-internet-protocol (“VoIP”) technology, such as that provided by such commercial concerns as Vonage® and Skype™. User 130 uses device 138, which may include a computer, a telephone equipped for VoIP communication such as an analog telephone adaptor, an IP phone, or some other item of VoIP-enabling hardware/software/firmware, to conduct a conversation by audio means with users 134 and 136 using device 140, which also may include a computer, a telephone equipped for VoIP communication such as an analog telephone adaptor, an IP phone, or some other item of VoIP-enabling hardware/software/firmware. The devices 138 and 140 are representative of any number of such devices that may be used to conduct a VoIP teleconference including any number of participating parties. Because VoIP uses packet switching, packets conveying audio data travel between the device 138 and the device 140 by different routes over the network 124 to be assembled in the proper order at their destinations. During a conversation in this exemplary environment, an audio data stream may be formed as packets are created and/or transmitted at a source device, either the device 138 or the device 140, and this audio data stream is reassembled at the destination device. Audio data streams may be formed and reassembled at the devices 138 and 140 simultaneously. Multiple audio data streams representing different speakers or other distinct audio information sources may be generated and reassembled by the devices 138 and/or 140 during a VoIP teleconference.

Where VoIP technology is being used in conjunction with users using standard telephone equipment connected to the Public Switched Telephone Network (“PSTN”), packets created by VoIP equipment such as the device 138 and/or 140 are conveyed over the network 124, reassembled by a device analogous to the devices 138 and/or 140, and transmitted to the standard telephone user over the PSTN.

An exemplary embodiment may include accepting input designating an audio aspect of an audio data stream created at the device 138 and/or the device 140, where the designation may be for the purpose or purposes of, e.g., retention at high resolution, interactive review of the portion of the audio data stream of interest, or analysis of the portion of interest. An exemplary embodiment may include accepting input for a designation of a reference designator in an audio data stream created at the device 138 and/or the device 140, accepting input for a designation of a beginning demarcation designator an audio data stream created at the device 138 and/or the device 140, accepting input for a designation of an ending demarcation designator an audio data stream created at the device 138 and/or the device 140, accepting input for retaining at high resolution, e.g., storing at high resolution in computer memory, audio data from the audio data stream beginning substantially at the beginning demarcation designator and ending substantially at the ending demarcation designator, and retaining at a high resolution such audio data. These operations may be performed by, for example the processor 126 and/or the processing logic 128, which may be incorporated with the device 138 and/or 140, partially incorporated with the device 138 and/or 140, or separated but operably coupled to the device 138 and/or 140. Each of these operations may be initiated by human action, e.g., the user 130 and/or 132 and/or 134 and/or 136 pressing a button, speaking into a microphone, and/or interacting with graphical user interface features, or they may be initiated by operation of some hardware/software/firmware, e.g., audio processing software such as the processor 126 and/or the processing logic 128, or they may be initiated by some combination of human and automated action. Each of these operations may be performed as an audio data stream is being created at the device 138 and/or 140, and/or as an audio data stream is being reassembled at the device 138 and/or 140, and/or as an audio data stream stored from a VoIP teleconference is played back or analyzed. Each of these operations may be performed in conjunction with an audio data stream in either analog or digital form.

A reference designator may include information such as an identifier that identifies the particular audio data stream of interest and a place in the audio data stream at which the information of interest is present, e.g., a place in the stream at which a particular speaker is speaking, and/or may fall within the audio data stream at such a place. A beginning demarcation designator may include an identifier that identifies the particular audio data stream of interest and an identifier of the first packet of a sequence of packets of interest and/or may fall within the audio data stream. An ending demarcation designator may include an identifier that identifies the particular audio data stream of interest and an identifier of the last packet of a sequence of packets of interest and/or may fall within the audio data stream.

Accepting input for retaining at high resolution a designated aspect of an audio data stream, as described elsewhere herein, may be performed, e.g., by using the devices 138 and/or 140 in addition to the devices for accepting input described in connection with FIG. 1A. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action. Retaining at a high resolution a portion of an audio data stream designated for retention at a high resolution, as described elsewhere herein, may be performed, e.g., using memory resources associated with and/or operably coupled to the devices 138 and/or 140 in addition to the devices for data retention described in connection with FIG. 1A.

Accepting input for degradation and/or retaining at a lower resolution a portion of an audio data stream not included in a portion of the audio data stream designated for retention at a high resolution, as described elsewhere herein, may be performed, e.g., by using the devices 138 and/or 140 in addition to the devices for accepting input described in connection with FIG. 1A. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action. Degradation and/or retaining at a lower resolution a portion of an audio data stream not included in a portion of the audio data stream designated for retention at a high resolution, as described elsewhere herein, may be performed, e.g., using memory resources associated with and/or operably coupled to the devices 138 and/or 140 in addition to the devices for data retention described in connection with FIG. 1A.

Those skilled in the art will appreciate that the explicitly described examples involving the network 124, the processor 126, the processing logic 128, the devices 138 and 140, and the exemplary users (users 130, 132, 134, and 136) constitute only a few of the aspects illustrated by FIG. 1B.

Following are a series of flowcharts depicting implementations of processes. For ease of understanding, the flowcharts are organized such that the initial flowcharts present implementations via an overall “big picture” viewpoint and thereafter the following flowcharts present alternate implementations and/or expansions of the “big picture” flowcharts as either sub-steps or additional steps building on one or more earlier-presented flowcharts. Those having skill in the art will appreciate that the style of presentation utilized herein (e.g., beginning with a presentation of a flowchart(s) presenting an overall view and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

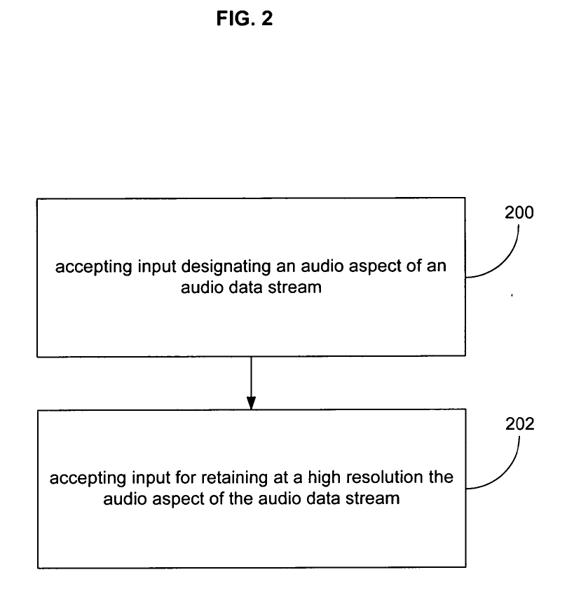

FIG. 2 depicts a high-level logic flowchart of an operational process. The illustrated process may include operation 200 and/or operation 202. Operation 200 shows accepting input designating an audio aspect of an audio data stream. Operation 200 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, for designating an instance of a particular voice and/or mechanical noise such as an automobile engine in an audio data stream, by means of e.g., a reference designator, specification of beginning and/or ending time indices, and/or specification of audio characteristics. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action.

Operation 202 depicts accepting input for retaining at a high resolution the audio aspect of the audio data stream. Operation 202 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, for retention, at a relatively high resolution, of the audio aspect of the audio data stream designated by the input accepted in operation 200 in one or more memory locations associated with and/or operably coupled to the digital video camera 102 and/or the digital video camera 106 and/or the sensor 114 and/or the sensor 116 and/or the processor 126 and/or the processing logic 128 and/or the device 138 and/or the device 140. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action.

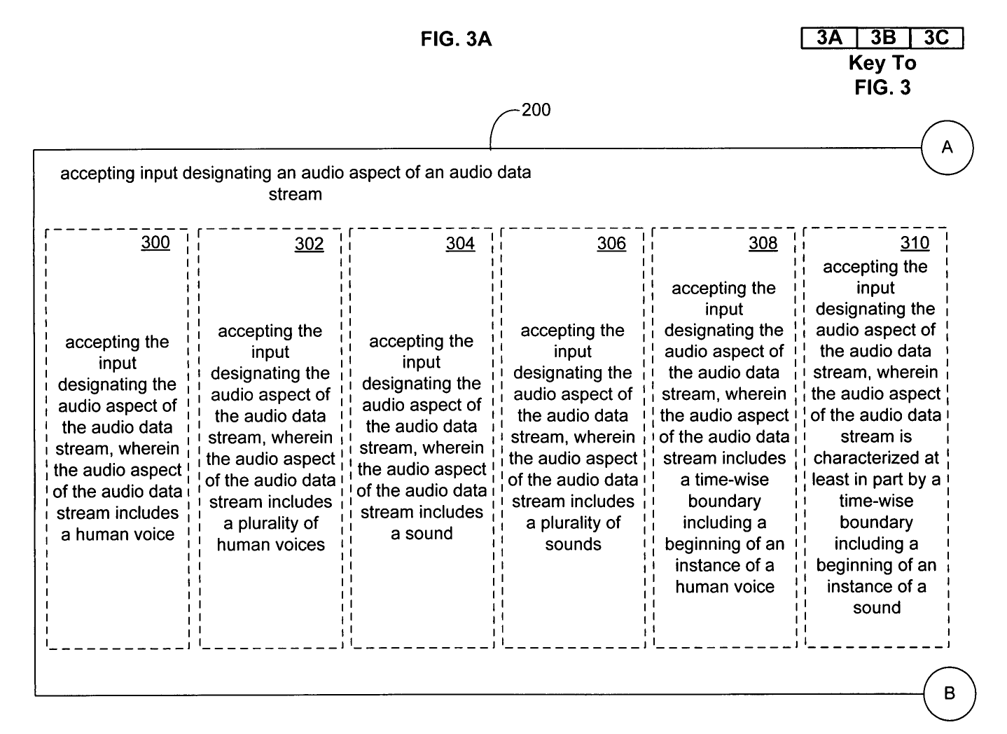

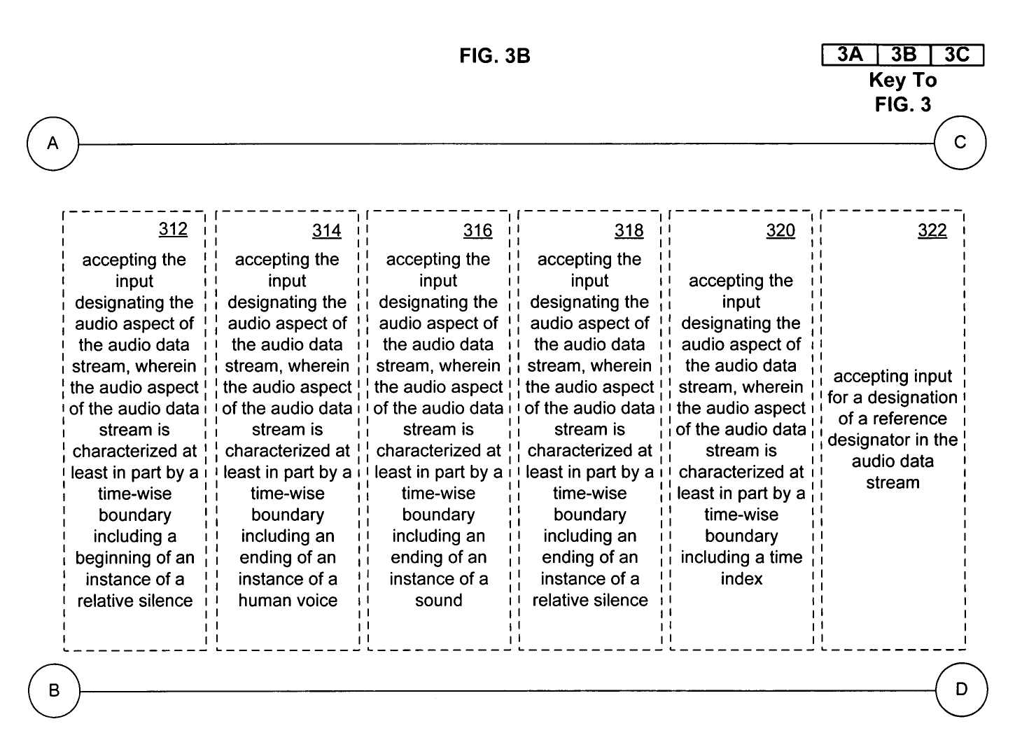

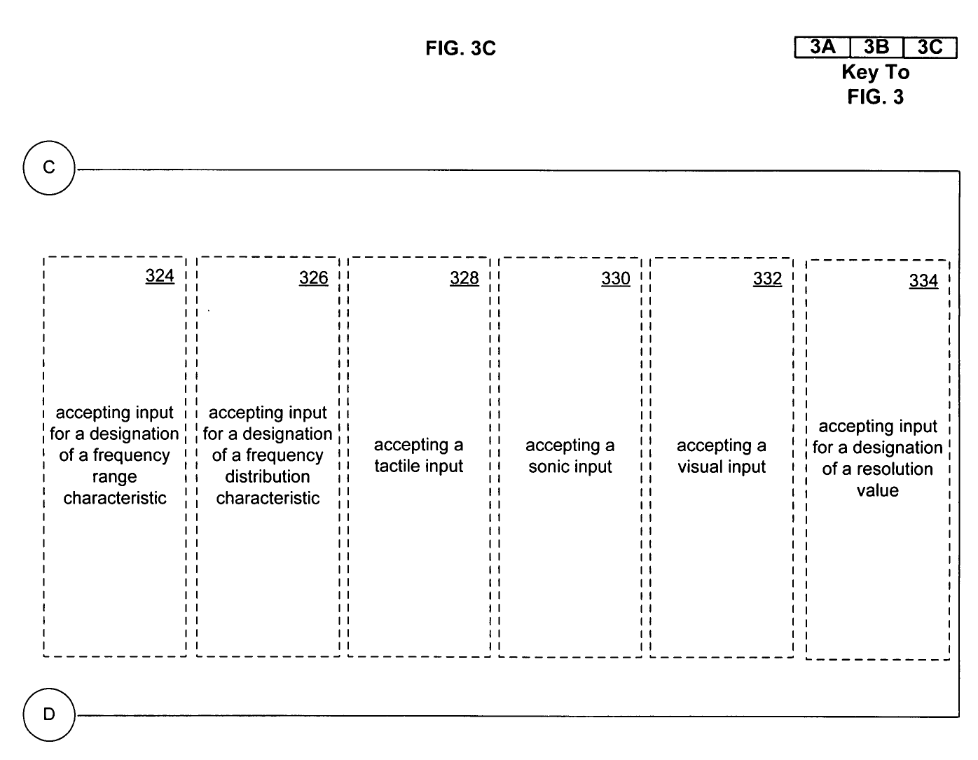

FIG. 3 shows several alternative implementations of the high-level logic flowchart of FIG. 2. Operation 200—accepting input designating an audio aspect of an audio data stream—may include one or more of the following operations: 300, 302, 304, 306, 308, 310, 312, 314, 316, 318, 320, 322, 324, 326, 328, 330, 332, and/or 334. Operation 300 shows accepting the input designating the audio aspect of the audio data stream, wherein the audio aspect of the audio data stream includes a human voice. Operation 300 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, for designating an instance of a distinct human voice, e.g., a sequence of utterances by a single speaker in a recorded conversation, where the voice may be temporally isolated or may be temporally overlapped by other voices and/or sounds but separable by use of distinct characteristics such as tonal quality or frequency. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action.

Operation 302 illustrates accepting the input designating the audio aspect of the audio data stream, wherein the audio aspect of the audio data stream includes a plurality of human voices. Operation 302 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, for designating a group of particular human voices, such as those of a set or a subset of people conducting a VoIP and/or a recorded conversation, where the voices of interest may be temporally isolated or may be temporally overlapped by each other or by extraneous voices and/or sounds but may be separable by use of distinct characteristics such as tonal quality or frequency. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action.

Operation 304 depicts accepting the input designating the audio aspect of the audio data stream, wherein the audio aspect of the audio data stream includes a sound. Operation 304 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, for designating a distinct sound, e.g., the sounds emitted from a particular musical instrument, a distinct and particular automobile engine's sonic emissions, where the sound of interest may be temporally isolated or may be temporally overlapped by other sounds but separable by use of distinct characteristics such as tonal quality or frequency. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action.

Operation 306 illustrates accepting the input designating the audio aspect of the audio data stream, wherein the audio aspect of the audio data stream includes a plurality of sounds. Operation 306 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, designating a group of particular sounds, such as those of a set or a subset of musical instrument sonic emissions or of a set or a subset of machinery sonic emissions, where the sounds of interest may be temporally isolated or may be temporally overlapped by each other or by extraneous voices and/or sounds but may be separable by use of distinct characteristics such as tonal quality or frequency. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action.

Operation 308 depicts accepting the input designating the audio aspect of the audio data stream, wherein the audio aspect of the audio data stream includes a time-wise boundary including a beginning of an instance of a human voice. Operation 308 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, for designating a point in time in the audio data stream at which a distinct human voice begins, e.g., the beginning of a spoken word, phrase, and/or sentence in the audio data stream. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action.

Operation 310 shows accepting the input designating the audio aspect of the audio data stream, wherein the audio aspect of the audio data stream is characterized at least in part by a time-wise boundary including a beginning of an instance of a sound. Operation 310 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, for designating a point in time in the audio data stream at which a distinct sound begins, e.g., the beginning of a bird call in the audio data stream. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action.

Operation 312 shows accepting the input designating the audio aspect of the audio data stream, wherein the audio aspect of the audio data stream is characterized at least in part by a time-wise boundary including a beginning of an instance of a relative silence. Operation 312 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, for designating a point in time in the audio data stream at which a distinct relative silence begins, e.g., the beginning of a silence except for background and/or artifact noise. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action.

Operation 314 depicts accepting the input designating the audio aspect of the audio data stream, wherein the audio aspect of the audio data stream is characterized at least in part by a time-wise boundary including an ending of an instance of a human voice. Operation 314 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, for designating a point in time in the audio data stream at which a distinct human voice ends, e.g., the end of a word, phrase, and/or sentence spoken by a particular human speaker of interest. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action.

Operation 316 illustrates accepting the input designating the audio aspect of the audio data stream, wherein the audio aspect of the audio data stream is characterized at least in part by a time-wise boundary including an ending of an instance of a sound. Operation 316 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, for designating a point in time in the audio data stream at which a distinct sound ends, e.g., the end of an animal's utterance or of a machine's sonic emissions. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action.

Operation 318 illustrates accepting the input designating the audio aspect of the audio data stream, wherein the audio aspect of the audio data stream is characterized at least in part by a time-wise boundary including an ending of an instance of a relative silence. Operation 318 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, for designating a point in time in the audio data stream at which a distinct relative silence ends, e.g., the ending of a silence except for background and/or artifact noise. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action.

Operation 320 shows accepting the input designating the audio aspect of the audio data stream, wherein the audio aspect of the audio data stream is characterized at least in part by a time-wise boundary including a time index. Operation 320 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, for designating a point in time in the audio data stream, where the point in time is defined with reference to a temporal reference point such as a beginning of the audio data stream. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action.

Operation 322 depicts accepting input for a designation of a reference designator in the audio data stream. Operation 322 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, for designating a reference designator in an audio data stream, marking and/or referring to a place in the audio data stream at which one or more voices and/or sounds of interest, such as the voice of a particular person or the noise generated by a particular device such as an auto engine, occur in the audio data stream. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action.

Operation 324 shows accepting input for a designation of a frequency range characteristic. Operation 324 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, for designation of a lower frequency bound and/or an upper frequency bound and/or a reference frequency bound together with specified frequency ranges above and/or below the reference frequency, e.g., designation of a lower bound of 100 Hz and/or an upper bound of 4000 Hz, or a reference frequency of 200 Hz together with a specified frequency range from 100 Hz below the reference frequency and 50 Hz above the reference frequency. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action.

Operation 326 depicts accepting input for a designation of a frequency distribution characteristic. Operation 326 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, designation of a particular frequency distribution that is characteristic of a sound of interest, such as a frequency distribution characteristic of a particular human voice. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action.

Operation 328 shows accepting a tactile input. Operation 328 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, where the input may be initiated by a user 104, 110, 118, 130, 132, 134, 136 mechanically manipulating an interface device and/or feature, such as a mouse input device and/or interacting with a drop-down menu of a graphical user interface.

Operation 330 shows accepting a sonic input. Operation 330 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, where the input may be initiated by a user 104, 110, 118, 130, 132, 134, 136 speaking and/or generating some sonic signal such as a click or a whistle into an interface device such as a microphone, or where the input may be initiated by an automated operation of the processor 126 and/or the processing logic 128 playing back a recording of such a sonic signal.

Operation 332 illustrates accepting a visual input. Operation 332 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, where the input may be initiated by a user 104, 110, 118, 130, 132, 134, 136 interacting with a video input device such as a camera and/or a light/infrared sensor and/or a visual component of a graphical user interface, or where the input may be initiated by an automated operation of the processor 126 and/or the processing logic 128 playing back a recording of a visual signal or of an interaction with a graphical user interface.

Operation 334 shows accepting input for a designation of a resolution value. Operation 334 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, for designation of a particular high resolution value for retention of the audio aspect of the audio data stream, such as 100 Kb/sec, as compared to a relatively lower resolution value for retention of audio data from the audio data stream that is not included in the audio aspect. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action.

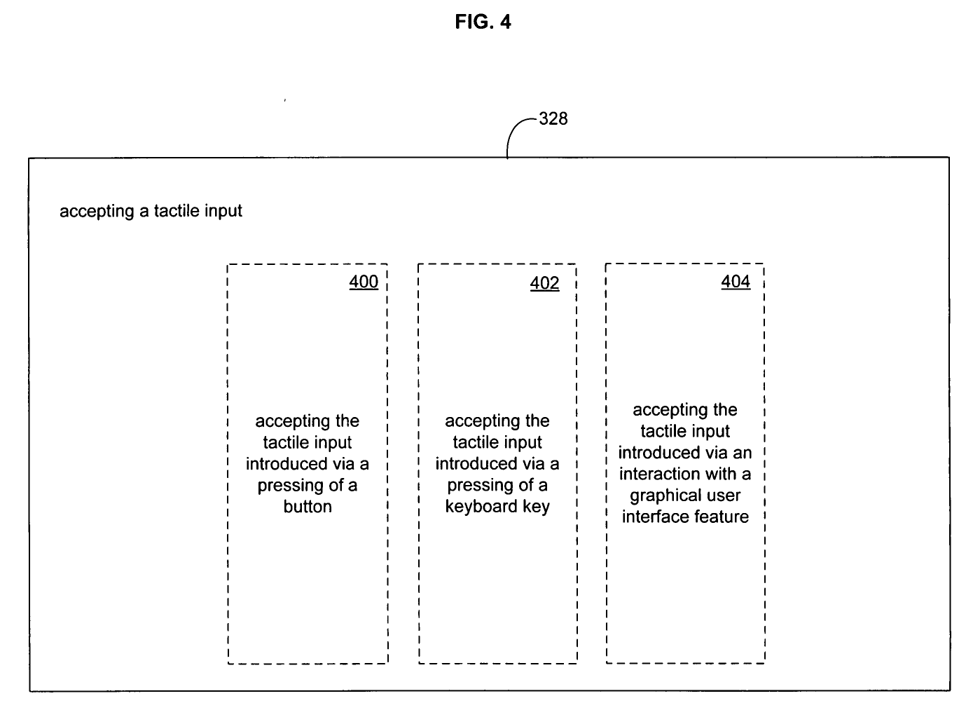

FIG. 4 shows several alternative implementations of the high-level logic flowchart of FIG. 3. Operation 328—accepting a tactile input—may include one or more of the following operations: 400, 402 and/or 404.

Operation 400 shows accepting the tactile input introduced via a pressing of a button. Operation 400 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, where the input is initiated by a user 104, 110, 118, 130, 132, 134, 136 mechanically manipulating a button on a mouse input device.

Operation 402 illustrates accepting the tactile input introduced via a pressing of a keyboard key. Operation 402 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, where the input is initiated by a user 104, 110, 118, 130, 132, 134, 136 mechanically manipulating a computer keyboard key.

Operation 404 depicts accepting the tactile input introduced via an interaction with a graphical user interface feature. Operation 404 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, where the input is initiated by a user 104, 110, 118, 130, 132, 134, 136 interacting with a button included in a graphical user interface.

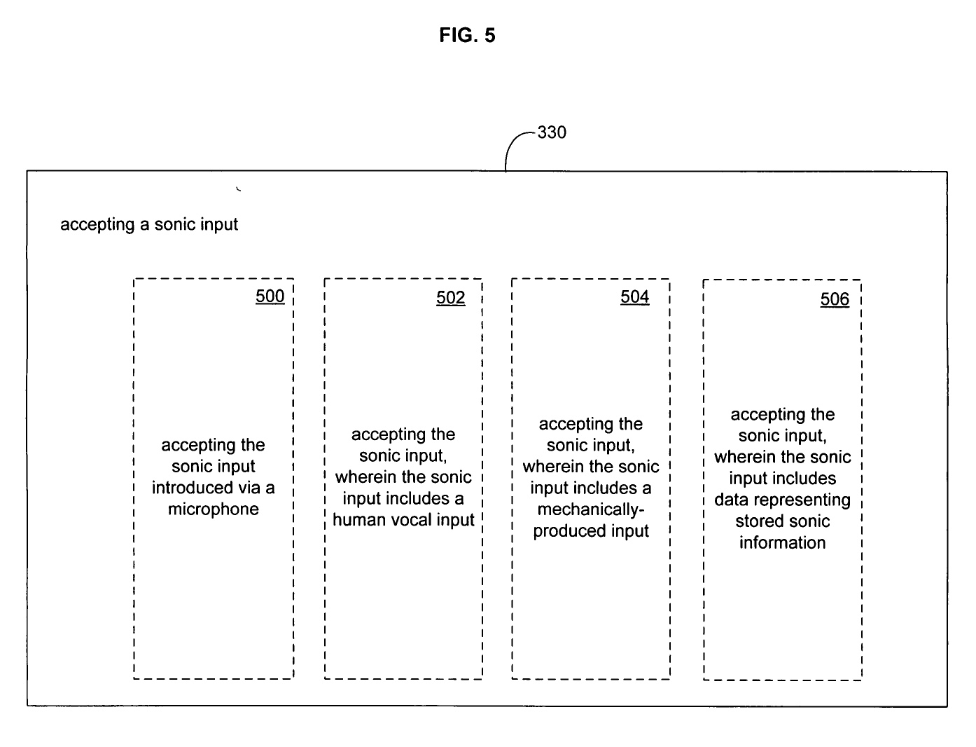

FIG. 5 shows several alternative implementations of the high-level logic flowchart of FIG. 3. Operation 330—accepting a sonic input—may include one or more of the following operations: 500, 502, 504 and/or 506.

Operation 500 illustrates accepting the sonic input introduced via a microphone. Operation 500 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, where the input is initiated by a user 104, 110, 118, 130, 132, 134, 136 causing a sound to be made that is detected by a microphone.

Operation 502 depicts accepting the sonic input, wherein the sonic input includes a human vocal input. Operation 502 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, where the input is initiated by a user 104, 110, 118, 130, 132, 134, 136 speaking into a microphone.

Operation 504 shows accepting the sonic input, wherein the sonic input includes a mechanically-produced input. Operation 504 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, where the input is initiated by a user 104, 110, 118, 130, 132, 134, 136 causing a sound to be made mechanically by a speaker.

Operation 506 illustrates accepting the sonic input, wherein the sonic input includes data representing stored sonic information. Operation 506 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, where the input is initiated by a user 104, 110, 118, 130, 132, 134, 136 playing back a recording of someone speaking into a microphone.

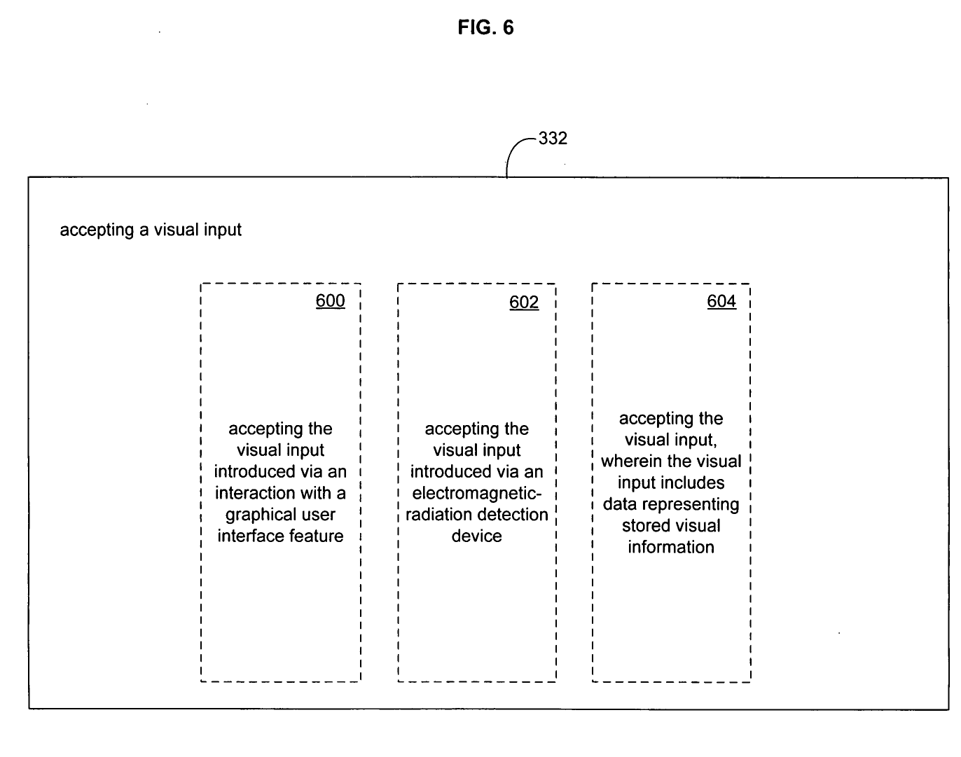

FIG. 6 shows several alternative implementations of the high-level logic flowchart of FIG. 3. Operation 332—accepting a visual input—may include one or more of the following operations: 600, 602 and/or 604.

Operation 600 depicts accepting the visual input introduced via an interaction with a graphical user interface feature. Operation 600 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, where the input is initiated by a user 104, 110, 118, 130, 132, 134, 136 interacting with a button in a visual presentation of a graphical user interface, or where the input is initiated by an automated operation of the processor 126 and/or the processing logic 128 playing back a recording of an interaction with a graphical user interface.

Operation 602 shows accepting the visual input introduced via an electromagnetic-radiation detection device. Operation 602 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, where the input is initiated by a user 104, 110, 118, 130, 132, 134, 136 causing a light flash that is detected by a camera or a light sensor, or where the input is initiated by an automated operation of the processor 126 and/or the processing logic 128 playing back a recording of such a visual signal.

Operation 604 illustrates accepting the visual input, wherein the visual input includes data representing stored visual information. Operation 604 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, where the input is initiated by a user 104, 110, 118, 130, 132, 134, 136 making a sign that is detected by a camera or by a user 104, 110, 118, 130, 132, 134, 136 playing back a video recording of a making a sign that is detected by a camera.

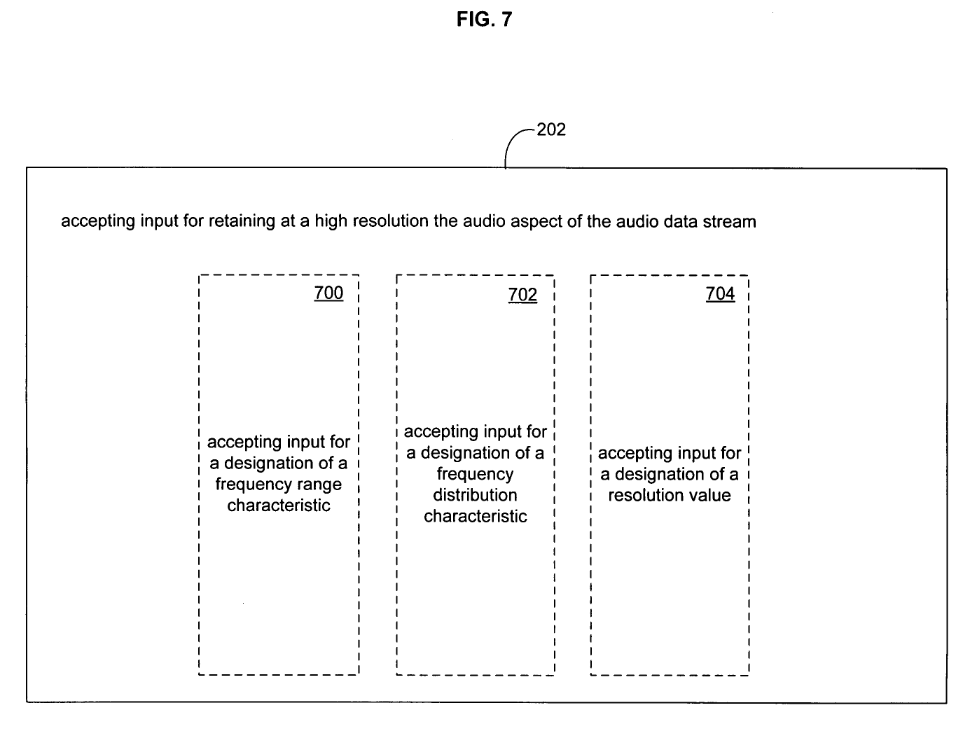

FIG. 7 illustrates several alternative implementations of the high-level logic flowchart of FIG. 2. Operation 202—accepting input for retaining at a high resolution the audio aspect of the audio data stream—may include one or more of the following operations: 700, 702, and/or 704.

Operation 700 shows accepting input for a designation of a frequency range characteristic. Operation 700 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, for designation of a lower frequency bound and/or an upper frequency bound and/or a reference frequency together with specified frequency ranges above and/or below the reference frequency, e.g., designation of a lower bound of 500 Hz and/or an upper bound of 6000 Hz, or a reference frequency of 300 Hz together with a specified frequency range from 100 Hz below the reference frequency to 75 Hz above the reference frequency. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action.

Operation 702 illustrates accepting input for a designation of a frequency distribution characteristic. Operation 702 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, designation of a particular frequency distribution that is characteristic of a sound of interest, such as the frequency distribution of the noise of a particular automobile engine. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action.

Operation 704 depicts accepting input for a designation of a resolution value. Operation 704 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, for designation of a particular high resolution value for retention of the audio aspect of the audio data stream, such as 96 K/sec, as compared to a relatively lower resolution value (such as 12 Kb/sec) for retention of audio data from the audio data stream that is not included in the audio aspect. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action.

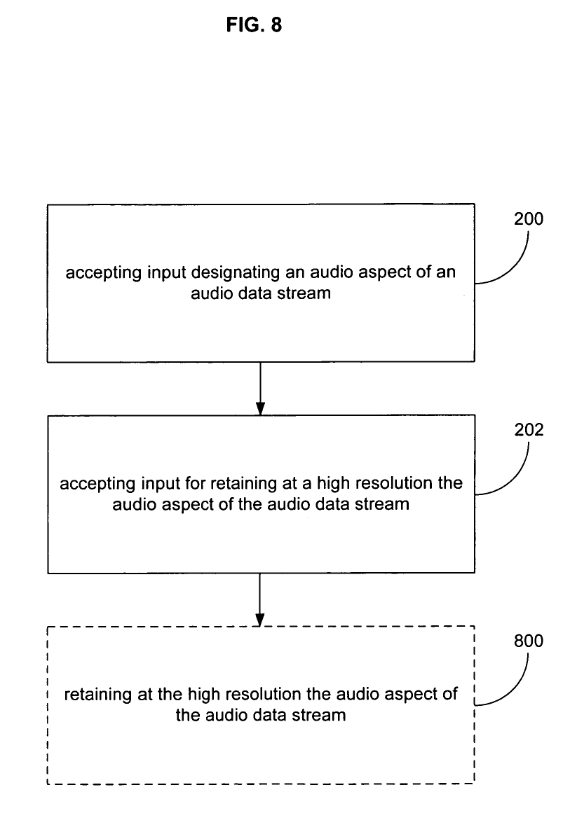

FIG. 8 shows a high-level logic flowchart of an operational process. Operation 800 illustrates retaining at the high resolution the audio aspect of the audio data stream. Operation 800 may include, for example, retaining an audio aspect of an audio data stream, where the audio aspect is designated by an input and such retention is in response to an input to retain the audio aspect, at a relatively high resolution in one or more memory locations associated with and/or operably coupled to the digital video camera 102 and/or the digital video camera 106 and/or the sensor 114 and/or the sensor 116 and/or the processor 126 and/or the processing logic 128 and/or the device 138 and/or the device 140. The relatively high resolution may be, for example, 96 Kb/sec as opposed to a lower resolution such as 12 Kb/sec for retention of portions of the audio data stream that are not included in the audio aspect to be retained at high resolution. The audio aspect may be, for example, an instance of a particular human voice or an instance of a particular airplane engine, and may be designated by means of, e.g., a reference designator, specification of beginning and/or ending time indices, and/or specification of audio characteristics. Such an audio data stream may be, for example, a play-back of a recorded and/or stored audio data stream or a live audio data stream being created or reassembled during, for instance, a VoIP teleconference. An input for retaining the audio aspect may be initiated by an action by a user 104, 110, 118, 130, 132, 134, 136, e.g., pressing a mouse input device button and/or speaking into a microphone, or the input may be initiated by operation of some hardware/software/firmware, e.g., audio processing software such as the processor 126 and/or the processing logic 128 and/or the devices 138, 140, or it may be initiated by some combination of human and automated action.

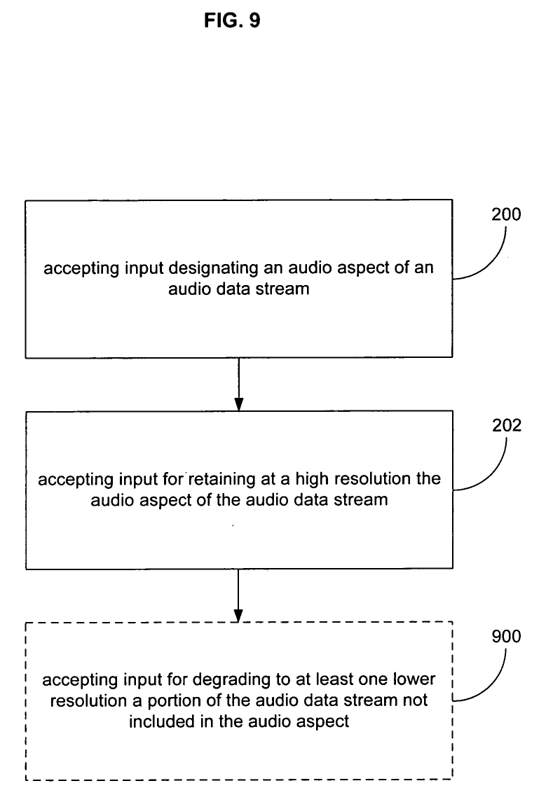

FIG. 9 depicts a high-level logic flow chart of an operational process. Operation 900 illustrates accepting input for degrading to at least one lower resolution a portion of the audio data stream not included in the audio aspect. Operation 900 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, for degrading, via, e.g., data redaction and/or data compression, to one or more relatively low resolutions for storage a portion of the audio data stream that is not included in the audio aspect designated for retention at high resolution, such as a block of audio data that is adjacent time-wise in the audio data stream to the audio aspect designated for retention at high resolution. This may include input for degradation of blocks of audio data before and/or after the audio aspect designated for retention at high resolution. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action.

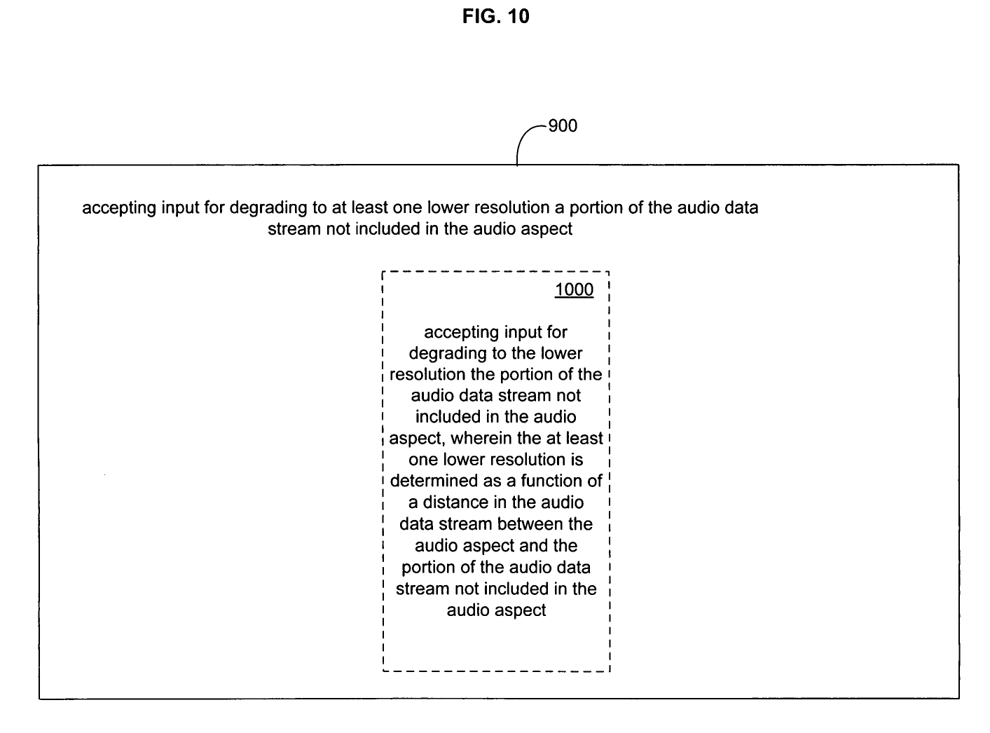

FIG. 10 illustrates an alternate implementation of the high-level logic flowchart of FIG. 9. Operation 1000 shows accepting input for degrading to the lower resolution the portion of the audio data stream not included in the audio aspect, wherein the at least one lower resolution is determined as a function of a distance in the audio data stream between the audio aspect and the portion of the audio data stream not included in the audio aspect. Operation 1000 may include, for example, accepting input, via the digital video camera 102 and/or the digital video camera 106 and/or the sensor 114 and/or the sensor 116 and/or the processor 126 and/or the processing logic 128 and/or the device 138 and/or the device 140, for degradation, via, e.g., data redaction and/or data compression, according to the distance between the portion to be degraded and the audio aspect designated for retention at high resolution, e.g., degradation to 75% of the audio data available in the audio data stream for a portion from between 0 and 30 seconds before the audio aspect designated for retention at high resolution, degradation to 50% of the audio data available in the audio data stream for a portion from between 30 and 60 seconds before the audio aspect designated for retention at high resolution, and degradation to 25% of the audio data available in the audio data stream for a portion from between 60 and 90 seconds before the audio aspect designated for retention at high resolution. Such an input may be initiated by an action by a user 104, 110, 118, 130, 132, 134, 136, e.g., pressing a mouse button and/or speaking into a microphone, or the input may be initiated by operation of some hardware/software/firmware, e.g., audio processing software such as the processor 126 and/or the processing logic 128 and/or devices 138, 140, or it may be initiated by some combination of human and automated action.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use engineering practices to integrate such described devices and/or processes into image processing systems. That is, at least a portion of the devices and/or processes described herein can be integrated into an image processing system via a reasonable amount of experimentation. Those having skill in the art will recognize that a typical image processing system generally includes one or more of a system unit housing, a video display device, a memory such as volatile and non-volatile memory, processors such as microprocessors and digital signal processors, computational entities such as operating systems, drivers, and applications programs, one or more interaction devices, such as a touch pad or screen, control systems including feedback loops and control motors (e.g., feedback for sensing lens position and/or velocity; control motors for moving/distorting lenses to give desired focuses. A typical image processing system may be implemented utilizing any suitable commercially available components, such as those typically found in digital still systems and/or digital motion systems.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

All of the above U.S. patents, U.S. patent application publications, U.S. patent applications, foreign patents, foreign patent applications and non-patent publications referred to in this specification and/or listed in any Application Data Sheet, are incorporated herein by reference, in their entireties.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A method related to data management, the method comprising:
accepting input designating an audio aspect of an audio data stream; and
accepting input for retaining at a high resolution the audio aspect of the audio data stream.

2. The method of claim 1, wherein the accepting input designating an audio aspect of an audio data stream further comprises:
accepting the input designating the audio aspect of the audio data stream, wherein the audio aspect of the audio data stream includes a human voice.

3. The method of claim 1, wherein the accepting input designating an audio aspect of an audio data stream further comprises:
accepting the input designating the audio aspect of the audio data stream, wherein the audio aspect of the audio data stream includes a plurality of human voices.

4. The method of claim 1, wherein the accepting input designating an audio aspect of an audio data stream further comprises:
accepting the input designating the audio aspect of the audio data stream, wherein the audio aspect of the audio data stream includes a sound.

5. The method of claim 1, wherein the accepting input designating an audio aspect of an audio data stream further comprises:
accepting the input designating the audio aspect of the audio data stream, wherein the audio aspect of the audio data stream includes a plurality of sounds.

6. The method of claim 1, wherein the accepting input designating an audio aspect of an audio data stream further comprises:
accepting the input designating the audio aspect of the audio data stream, wherein the audio aspect of the audio data stream includes a time-wise boundary including a beginning of an instance of a human voice.

7. The method of claim 1, wherein the accepting input designating an audio aspect of an audio data stream further comprises:
accepting the input designating the audio aspect of the audio data stream, wherein the audio aspect of the audio data stream is characterized at least in part by a time-wise boundary including a beginning of an instance of a sound.

8. The method of claim 1, wherein the accepting input designating an audio aspect of an audio data stream further comprises:
accepting the input designating the audio aspect of the audio data stream, wherein the audio aspect of the audio data stream is characterized at least in part by a time-wise boundary including a beginning of an instance of a relative silence.

9. The method of claim 1, wherein the accepting input designating an audio aspect of an audio data stream further comprises:
accepting the input designating the audio aspect of the audio data stream, wherein the audio aspect of the audio data stream is characterized at least in part by a time-wise boundary including an ending of an instance of a human voice.

10. The method of claim 1, wherein the accepting input designating an audio aspect of an audio data stream further comprises:
accepting the input designating the audio aspect of the audio data stream, wherein the audio aspect of the audio data stream is characterized at least in part by a time-wise boundary including an ending of an instance of a sound.

11. The method of claim 1, wherein the accepting input designating an audio aspect of an audio data stream further comprises:
accepting the input designating the audio aspect of the audio data stream, wherein the audio aspect of the audio data stream is characterized at least in part by a time-wise boundary including an ending of an instance of a relative silence.

12. The method of claim 1, wherein the accepting input designating an audio aspect of an audio data stream further comprises:
accepting the input designating the audio aspect of the audio data stream, wherein the audio aspect of the audio data stream is characterized at least in part by a time-wise boundary including a time index.

13. The method of claim 1, wherein the accepting input designating an audio aspect of an audio data stream further comprises:
accepting input for a designation of a reference designator in the audio data stream.

14. The method of claim 1, wherein the accepting input designating an audio aspect of an audio data stream further comprises:
accepting input for a designation of a frequency range characteristic.

15. The method of claim 1, wherein the accepting input designating an audio aspect of an audio data stream further comprises:
accepting input for a designation of a frequency distribution characteristic.

16. The method of claim 1, wherein the accepting input designating an audio aspect of an audio data stream further comprises:
accepting a tactile input.

17. The method of claim 16, wherein the accepting a tactile input further comprises:
accepting the tactile input introduced via a pressing of a button.

18. The method of claim 16, wherein the accepting a tactile input further comprises:
accepting the tactile input introduced via a pressing of a keyboard key.

19. The method of claim 16, wherein the accepting a tactile input further comprises:
accepting the tactile input introduced via an interaction with a graphical user interface feature.

20. The method of claim 1, wherein the accepting input designating an audio aspect of an audio data stream further comprises:
accepting a sonic input.

21. The method of claim 20, wherein the accepting a sonic input further comprises:
accepting the sonic input introduced via a microphone.

22. The method of claim 20, wherein the accepting a sonic input further comprises:
accepting the sonic input, wherein the sonic input includes a human vocal input.

23. The method of claim 20, wherein the accepting a sonic input further comprises:
accepting the sonic input, wherein the sonic input includes a mechanically-produced input.

24. The method of claim 20, wherein the accepting a sonic input further comprises:
accepting the sonic input, wherein the sonic input includes data representing stored sonic information.

25. The method of claim 1, wherein the accepting input designating an audio aspect of an audio data stream further comprises:
accepting a visual input.

26. The method of claim 25, wherein the accepting a visual input further comprises:
accepting the visual input introduced via an interaction with a graphical user interface feature.

27. The method of claim 25, wherein the accepting a visual input further comprises:
accepting the visual input introduced via an electromagnetic-radiation detection device.

28. The method of claim 25, wherein the accepting a visual input further comprises:
accepting the visual input, wherein the visual input includes data representing stored visual information.

29. The method of claim 1, wherein the accepting input designating an audio aspect of an audio data stream further comprises:
accepting input for a designation of a resolution value.

30. The method of claim 1, wherein the accepting input for retaining at a high resolution the audio aspect of the audio data stream further comprises:
accepting input for a designation of a frequency range characteristic.

31. The method of claim 1, wherein the accepting input for retaining at a high resolution the audio aspect of the audio data stream further comprises:
accepting input for a designation of a frequency distribution characteristic.

32. The method of claim 1, wherein the accepting input for retaining at a high resolution the audio aspect of the audio data stream further comprises:
accepting input for a designation of a resolution value.

33. The method of claim 1, further comprising:
retaining at the high resolution the audio aspect of the audio data stream.

34. The method of claim 1, further comprising:
accepting input for degrading to at least one lower resolution a portion of the audio data stream not included in the audio aspect.

35. The method of claim 34, wherein the accepting input for degrading to at least one lower resolution a portion of the audio data stream not included in the audio aspect further comprises:
accepting input for degrading to the lower resolution the portion of the audio data stream not included in the audio aspect, wherein the at least one lower resolution is determined as a function of a distance in the audio data stream between the audio aspect and the portion of the audio data stream not included in the audio aspect.

36. A system related to data management, the system comprising:
circuitry for accepting input designating an audio aspect of an audio data stream; and
circuitry for accepting input for retaining at a high resolution the audio aspect of the audio data stream.

37. The system of claim 36, further comprising:
circuitry for retaining at the high resolution the audio aspect of the audio data stream.

38. The system of claim 36, further comprising:
circuitry for accepting input for degrading to at least one lower resolution a portion of the audio data stream not included in the audio aspect.

39. A system related to data management, the system comprising:
means for accepting input designating an audio aspect of an audio data stream; and
means for accepting input for retaining at a high resolution the audio aspect of the audio data stream.

40. The system of claim 39, further comprising:
means for retaining at the high resolution the audio aspect of the audio data stream.

41. The system of claim 39, further comprising:
means for accepting input for degrading to at least one lower resolution a portion of the audio data stream not included in the audio aspect.

42. A program product related to data management, the program product comprising:
a signal bearing medium bearing
one or more instructions for accepting input designating an audio aspect of an audio data stream; and
one or more instructions for accepting input for retaining at a high resolution the audio aspect of the audio data stream.

43. The program product of claim 42, wherein the signal-bearing medium comprises:
a recordable medium.

44. The program product of claim 42, wherein the signal-bearing medium comprises:
a transmission medium.

45. The program product of claim 42, wherein the one or more instructions for accepting input designating an audio aspect of an audio data stream further comprise:
one or more instructions for accepting the input designating the audio aspect of the audio data stream, wherein the audio aspect of the audio data stream includes a human voice.

46. The program product of claim 42, wherein the one or more instructions for accepting input designating an audio aspect of an audio data stream further comprise:
one or more instructions for accepting the input designating the audio aspect of the audio data stream, wherein the audio aspect of the audio data stream includes a plurality of human voices.

47. The program product of claim 42, wherein the one or more instructions for accepting input designating an audio aspect of an audio data stream further comprise:
one or more instructions for accepting the input designating the audio aspect of the audio data stream, wherein the audio aspect of the audio data stream includes a sound.

48. The program product of claim 42, wherein the one or more instructions for accepting input designating an audio aspect of an audio data stream further comprise:
one or more instructions for accepting the input designating the audio aspect of the audio data stream, wherein the audio aspect of the audio data stream includes a plurality of sounds.

49. The program product of claim 42, wherein the one or more instructions for accepting input designating an audio aspect of an audio data stream further comprise:
one or more instructions for accepting the input designating the audio aspect of the audio data stream, wherein the audio aspect of the audio data stream includes a time-wise boundary including a beginning of an instance of a human voice.

50. The program product of claim 42, wherein the one or more instructions for accepting input designating an audio aspect of an audio data stream further comprise:
one or more instructions for accepting the input designating the audio aspect of the audio data stream, wherein the audio aspect of the audio data stream is characterized at least in part by a time-wise boundary including a beginning of an instance of a sound.

51. The program product of claim 42, wherein the one or more instructions for accepting input designating an audio aspect of an audio data stream further comprise:
one or more instructions for accepting the input designating the audio aspect of the audio data stream, wherein the audio aspect of the audio data stream is characterized at least in part by a time-wise boundary including a beginning of an instance of a relative silence.

52. The program product of claim 42, wherein the one or more instructions for accepting input designating an audio aspect of an audio data stream further comprise:
one or more instructions for accepting the input designating the audio aspect of the audio data stream, wherein the audio aspect of the audio data stream is characterized at least in part by a time-wise boundary including an ending of an instance of a human voice.

53. The program product of claim 42, wherein the one or more instructions for accepting input designating an audio aspect of an audio data stream further comprise:
one or more instructions for accepting the input designating the audio aspect of the audio data stream, wherein the audio aspect of the audio data stream is characterized at least in part by a time-wise boundary including an ending of an instance of a sound.

54. The program product of claim 42, wherein the one or more instructions for accepting input designating an audio aspect of an audio data stream further comprise:
one or more instructions for accepting the input designating the audio aspect of the audio data stream, wherein the audio aspect of the audio data stream is characterized at least in part by a time-wise boundary including an ending of an instance of a relative silence.

55. The program product of claim 42, wherein the one or more instructions for accepting input designating an audio aspect of an audio data stream further comprise:
one or more instructions for accepting the input designating the audio aspect of the audio data stream, wherein the audio aspect of the audio data stream is characterized at least in part by a time-wise boundary including a time index.

56. The program product of claim 42, wherein the one or more instructions for accepting input designating an audio aspect of an audio data stream further comprise:
one or more instructions for accepting input for a designation of a reference designator in the audio data stream.

57. The program product of claim 42, wherein the one or more instructions for accepting input designating an audio aspect of an audio data stream further comprise:
one or more instructions for accepting input for a designation of a frequency range characteristic.

58. The program product of claim 42, wherein the one or more instructions for accepting input designating an audio aspect of an audio data stream further comprise:
one or more instructions for accepting input for a designation of a frequency distribution characteristic.

59. The program product of claim 42, wherein the one or more instructions for accepting input designating an audio aspect of an audio data stream further comprise:
one or more instructions for accepting a tactile input.

60. The program product of claim 59, wherein the one or more instructions for accepting a tactile input further comprise:
one or more instructions for accepting the tactile input introduced via a pressing of a button.

61. The program product of claim 59, wherein the one or more instructions for accepting a tactile input further comprise:
one or more instructions for accepting the tactile input introduced via a pressing of a keyboard key.

62. The program product of claim 59, wherein the one or more instructions for accepting a tactile input further comprise:
one or more instructions for accepting the tactile input introduced via an interaction with a graphical user interface feature.

63. The program product of claim 42, wherein the one or more instructions for accepting input designating an audio aspect of an audio data stream further comprise:
one or more instructions for accepting a sonic input.

64. The program product of claim 63, wherein the one or more instructions for accepting a sonic input further comprise:
one or more instructions for accepting the sonic input introduced via a microphone.

65. The program product of claim 63, wherein the one or more instructions for accepting a sonic input further comprise:
one or more instructions for accepting the sonic input, wherein the sonic input includes a human vocal input.

66. The program product of claim 63, wherein the one or more instructions for accepting a sonic input further comprise:
one or more instructions for accepting the sonic input, wherein the sonic input includes a mechanically-produced input.

67. The program product of claim 63, wherein the one or more instructions for accepting a sonic input further comprise:
one or more instructions for accepting the sonic input, wherein the sonic input includes data representing stored sonic information.

68. The program product of claim 42, wherein the one or more instructions for accepting input designating an audio aspect of an audio data stream further comprise:
one or more instructions for accepting a visual input.

69. The program product of claim 68, wherein the one or more instructions for accepting a visual input further comprise:
one or more instructions for accepting the visual input introduced via an interaction with a graphical user interface feature.

70. The program product of claim 68, wherein the one or more instructions for accepting a visual input further comprise:
one or more instructions for accepting the visual input introduced via an electromagnetic-radiation detection device.

71. The program product of claim 68, wherein the one or more instructions for accepting a visual input further comprise:
one or more instructions for accepting the visual input, wherein the visual input includes data representing stored visual information.

72. The program product of claim 42, wherein the one or more instructions for accepting input designating an audio aspect of an audio data stream further comprise:
one of more instructions for accepting input for a designation of a resolution value.

73. The program product of claim 42, wherein the one or more instructions for accepting input for retaining at a high resolution the audio aspect of the audio data stream further comprise:
one or more instructions for accepting input for a designation of a frequency range characteristic.

74. The program product of claim 42, wherein the one or more instructions for accepting input for retaining at a high resolution the audio aspect of the audio data stream further comprise:
one or more instructions for accepting input for a designation of a frequency distribution characteristic.

75. The program product of claim 42, wherein the one or more instructions for accepting input for retaining at a high resolution the audio aspect of the audio data stream further comprise:
one or more instructions for accepting input for a designation of a resolution value.

76. The program product of claim 42, wherein the signal bearing medium further comprises:
one or more instructions for retaining at the high resolution the audio aspect of the audio data stream.

77. The program product of claim 42, wherein the signal bearing medium further comprises:
one or more instructions for accepting input for degrading to at least one lower resolution a portion of the audio data stream not included in the audio aspect.

78. The program product of claim 77, wherein the one or more instructions for accepting input for degrading to at least one lower resolution a portion of the audio data stream not included in the audio aspect further comprise:
one or more instructions for accepting input for degrading to the lower resolution the portion of the audio data stream not included in the audio aspect, wherein the at least one lower resolution is determined as a function of a distance in the audio data stream between the audio aspect and the portion of the audio data stream not included in the audio aspect.
